(19) United States
(12) Patent Application Publication
(10) Pub. No.: US 2005/0191466 A1
(43) Pub. Date: Sep. 1, 2005

(54) Laminate structural material trim and applications thereof

(75) Inventor: Daniel J. Andrade, Raynham, MA (US)

Correspondence Address: PERKINS, SMITH & COHEN LLP, ONE BEACON STREET, 30TH FLOOR, BOSTON, MA, 02108, US

(73) Assignee: Advanced Trimworks, Inc., Raynham, MA (US)

(21) Appl. No.: 11/051,048

(22) Filed: Feb. 4, 2005

Related U.S. Application Data
(63) Continuation of application No. PCT/US04/15287, filed on May 14, 2004.
(60) Provisional application No. 60/541,656, filed on Feb. 4, 2004.
(60) Provisional application No. 60/470,552, filed on May 14, 2003.

(51) Int. Cl. B32B 7/00

(52) U.S. Cl. 428/167

(57) ABSTRACT

Synthetic laminate structures and mounting assemblies for use therewith. Multi-sectional clip structures are provided for use individually or jointly in securing synthetic trim mountings.

### CROSS REFERENCE TO RELATED APPLICATIONS

This application claims priority to and the benefit of U.S. Provisional Application Ser. No. 60/541,656, filed Feb. 4, 2004 and International Application PCT/US2004/015287, filed May 14, 2004, which in turn additionally claims priority to Provisional Application Ser. No. 60/470,552, the contents of each is incorporated herein by reference in their entirety.

### FIELD OF THE INVENTION

The present invention relates generally to building materials, and more specifically to an apparatus for aesthetically-pleasing trim and certain load-bearing applications using, for example, trimboard composed of a laminate polyvinyl product.

### BACKGROUND OF THE INVENTION

In home construction finishing, wood is often used due to its workability, economy, structural strength and desired appearance. However, wood is susceptible to a number of potential dangers that may shortly degrade its structural fitness and aesthetic appearance. For example, the effects of moisture, changing temperatures, UV light and insects may cause wood used in a visible location to swell, rot, split, cup, craze or weaken.

Recently developed cellular polyvinyl chloride (PVC) materials are being marketed for use as trimboards, cornerboards and/or beadboards. Some examples include KOMA™ trimboards (U.S. Pat. No. 4,141,944), marketed and distributed by Kömmerling Kunststoff GmbH (Huntsville, Ala.), and AZEK™ trimboards manufactured by Vycom Corp. (Moosic, Pa.). Such materials have desirable characteristics including water resistance, insect resistance, fire retardance, and workability with the same tools as would be used with wood. However, such materials have not been employed in applications requiring more structural support.

Thus, what is needed is a material having the durability of PVC-based trimboards that can be used in simple structures (e.g., railings, fences), where the structural strength requirements have necessitated use of alternative building materials.

It is also desirable to be able to provide further mechanical support for such structures in applications where a load will be borne by the laminate structures.

It is additionally desirable to provide mechanisms for seamlessly applying any type of trimboard to corners, posts or columns, or windows in a manner that hides fasteners, such as nails, screws and/or bolts, from view.

### SUMMARY OF THE INVENTION

The inventor has developed additional implementations and accessories for the laminates described in PCT Application PCT/US2004/015287 filed May 14, 2004 entitled, “Synthetic Resin Structures and Mountings for such Structures”, which claims priority to U.S. Provisional Application Ser. No. 60/470,552 entitled “Laminate Structural Material and Method of Manufacture Thereof”, filed May 14, 2003, both of which are incorporated herein by reference in its entirety. Those applications describe (a) inventive methods for producing a plastic product meeting the needs described above, and (b) structural assemblies that enable use in structures such as, for example, pergolas, picket fences, railings, gazebos, etc. Such plastics can be assembled on site using low-level labor or ordinary consumer skills, and structures having enhanced aesthetics can be easily disassembled and reassembled.

In one aspect, the present invention provides a method of producing a laminate material that is highly durable, aesthetically pleasing, and suitable for construction projects wherein no screws or nails are externally visible. In this embodiment, the invention makes use of PVC-based trimboard materials to form a multilayer laminate comprised of multiple layers of the trimboard. Various means of adhering the trimboards may be employed. The laminate exhibits increased stiffness and strength, as well as an improved resistance to microcracking after a prolonged period of use in the field. The composite structure also generally exhibits increased longitudinal shear strength. The structure also exhibits increased axial load strength proportional to the thickness and number of trimboard layers employed. After formation, the composite laminate may then be employed as workable components in a wide range of assemblies.

In another aspect, the present invention provides various means of using the laminate in structures such as railings for increased structural support. In one embodiment, sections of laminate intended to be used as handrail supports are reinforced with segments of rigid material such as aluminum.

In another aspect, the present invention provides a reinforcing core for a hollow post, such as may be used in decking. The hollow post may have any cross-sectional shape, but is preferably square or rectangular. The reinforcing core may be used with posts formed of the inventive laminate so as to show no external screws or nails, or may be used more generally with other building materials. The reinforcing core makes use of a plurality of symmetrically disposed positioning screws to properly orient the post it is reinforcing. The reinforcing core also includes a bottom plate for securing the reinforcing core to a floor, ground or deck surface.

In yet another aspect, the present invention provides various means for attaching trimboards composed of any material, advantageously the inventive laminates but not limited to said laminate materials, to external surfaces, corners or windows in a manner in which no fasteners (e.g., nails or screws) are externally visible. These embodiments employ rigid clip mechanisms that allow use of trimboards in both new constructions and retrofits, and provide increased stability to structures, such as windows, compared to existing window trim installations, which typically merely abut the window.

### BRIEF DESCRIPTION OF THE FIGURES OF THE DRAWING

For a better understanding of the present invention, together with other and further objects thereof, reference is made to the accompanying drawing and detailed description, wherein:

FIG. 1 is an illustration of a composite laminate structure in accordance with the present invention;

FIG. 2a is a cross-sectional view of a laminate sheet that has been mitered to create preferred shaped grooves in accordance with the present invention;

FIG. 2b is an illustration of a solid post that may be created by folding mitered sections of a laminate sheet, such as shown in FIG. 2a, in accordance with the present invention;

FIG. 2c is an illustration of a square hollow column that may be created by folding mitered sections of a laminate sheet, such as shown in FIG. 2a, in accordance with the present invention;

FIG. 2d is an illustration of a hexagonal hollow column that may be created by folding mitered sections of a laminate sheet, such as shown in FIG. 2a, in accordance with the present invention;

FIG. 2e is an illustration of a rectangular hollow collar for a post that may be created by folding mitered sections of a laminate sheet, such as shown in FIG. 2a, in accordance with the present invention;

FIG. 3a is a perspective view of the hollow column of FIG. 2c;

FIG. 3b is a perspective view of the hollow column of FIG. 2d;

FIG. 4 is a schematic diagram of the components of a railing assembly in accordance with the present invention;

FIG. 5 is a schematic diagram of the components of a railing assembly, including a reinforcement channel, in accordance with the present invention;

FIG. 6 is a schematic diagram of the railing assembly of FIG. 4 being attached to a hollow support column;

FIG. 7 is a schematic diagram of a top cap to be affixed atop the support column of FIG. 6;

FIG. 8 is a schematic illustration of components of a post core reinforcement mechanism to be received within the hollow support column of the present invention;

FIGS. 9a, 9b, 9c and 9d show the steps of assembling the railing assembly using the components of FIGS. 4-8.

FIGS. 10a and 10b are side and top views of a first trim clip of the present invention;

FIG. 10c is a view of the first trim clip of the present invention for mounting corner trim;

FIG. 10d is a view of the first trim clip of the present invention for mounting window trim;

FIG. 11a is a perspective view of a second trim clip of the present invention;

FIGS. 11b and 11c are views of the second trim clip of the present invention for mounting flat trim;

FIGS. 12a and 12b are schematic illustrations of a window trim mounting assembly in accordance with the present invention; and

FIGS. 12c, 12d, and 12e are illustrations of the window trim mounting assembly of FIGS. 12a-b in use.

### DETAILED DESCRIPTION OF PREFERRED EMBODIMENTS OF THE INVENTION

Preferred embodiments of the present invention will now be described with reference to the several figures of the drawing.

In one aspect, the present invention provides a method of producing a laminate material that is highly durable, aesthetically pleasing, and suitable for construction projects wherein no screws or nails are externally visible.

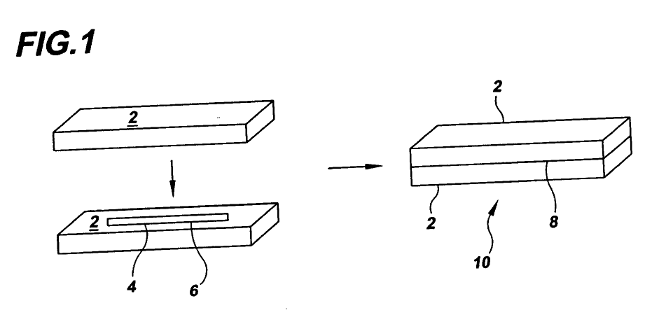

The invention makes use of PVC-based trimboard materials, such as those described above, in their commercially available sizes (i.e., up to 1″ thick) to create a multilayer laminate comprised of multiple layers of the trimboard. With reference to FIG. 1, each layer of trimboard 2 adjacent to another is fastened to the other via one or more of a variety of means. Because the trimboard material is robustly workable, the trimboards may be affixed to one another by conventional nailing and/or screwing. In a preferred embodiment, adjacent layers 2 are bonded by construction adhesive or PVC cement, such as commercially available 2P-10™ manufactured by FastCap, LLC (Bellingham, Wash.), or Gorilla Glue™ (U.S. Pat. No. 4,675,354 to Sperling) manufactured by Gorilla PVC Cement LLC (Hollywood, Fla.). These glues are invisible, quick-setting and suitable for indoor or outdoor uses, and may be employed in bonding the laminate to materials such as wood, stone, metal, ceramics and other plastics. The laminates can be easily painted prior to use in laminate assemblies, but preferably are painted after an assembly has been completed (so as not to interfere with proper dimensioning of sub-assemblies.)

In FIG. 1, a fine bead of adhesive 4 is preferentially placed along the center 6 of the planar interface 8 between adjacent trimboards 2, in such a manner as to prevent excess adhesive from seeping out from the layer between any two trimboards. The adhesives are also easily sanded, which may be necessary following a laminate cutting operation. The trimboard surfaces at the laminate interface may be smoothed mechanically or chemically, or otherwise processed, to maximize delamination resistance.

A composite laminate structure 10 prepared in accordance with this invention exhibits an increased stiffness and strength in a direction normal to the planar interface between trimboards, as well as an improved resistance to microcracking after a prolonged period of use in the field. The composite structure also generally exhibits increased longitudinal shear strength. The structure also exhibits increased axial load strength proportional to the thickness and number of trimboard layers employed.

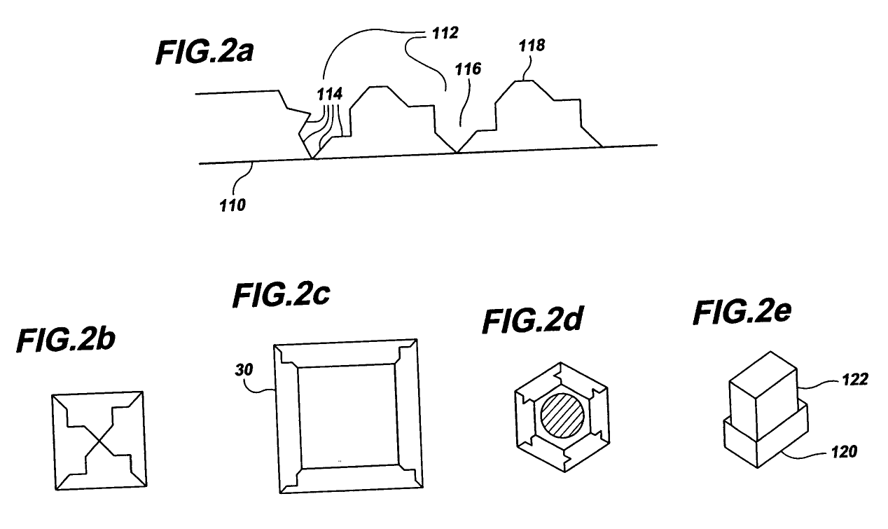

FIG. 2a shows a cross-sectional view of a laminate sheet that has been mitered to exhibit shaped grooves 112. While various shaped grooves (e.g., more curved or displaying more angled features) may be used, the pattern illustrated is particularly useful in allowing a single piece of laminate to be folded into a variety of shapes that exhibit nearly seamless combination. As shown, the grooves 112 do not go all the way through the laminate, but are cut sufficiently deep so as to allow for folding of the laminate sheet. When the sheet is folded, adhesives, glues or epoxies as described above are applied to the contact surfaces 114 to assure mechanical strength.

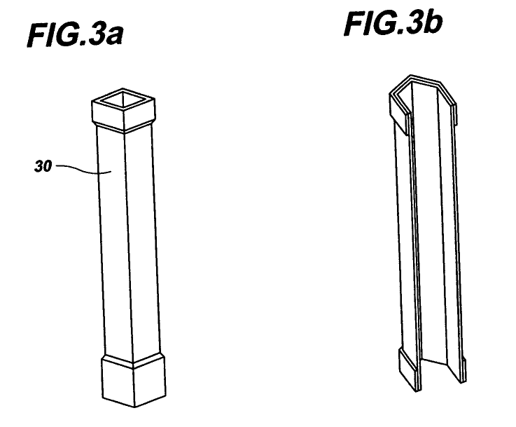

FIGS. 2b-e illustrate a sample of the structures that can be formed by adjusting the groove angles 116 and spacings 118 between the grooves. FIG. 2b illustrates a solid beam formed from the folded sheet. FIG. 2c illustrates a hollow variation that may be suitable for use as the support column 30 of the railing system below. FIG. 2d illustrates a variation that may be used as a decorative covering to concrete columns in imitation of a Roman style. Each of these shaped components can be made of any desired length, and may be used, for example as a decorative collar-like finish 120 to a post or column 122, such as illustrated in FIG. 2e. FIG. 3a and FIG. 3b show a perspective view of the hollow columns of FIG. 2c and FIG. 2d, respectively.

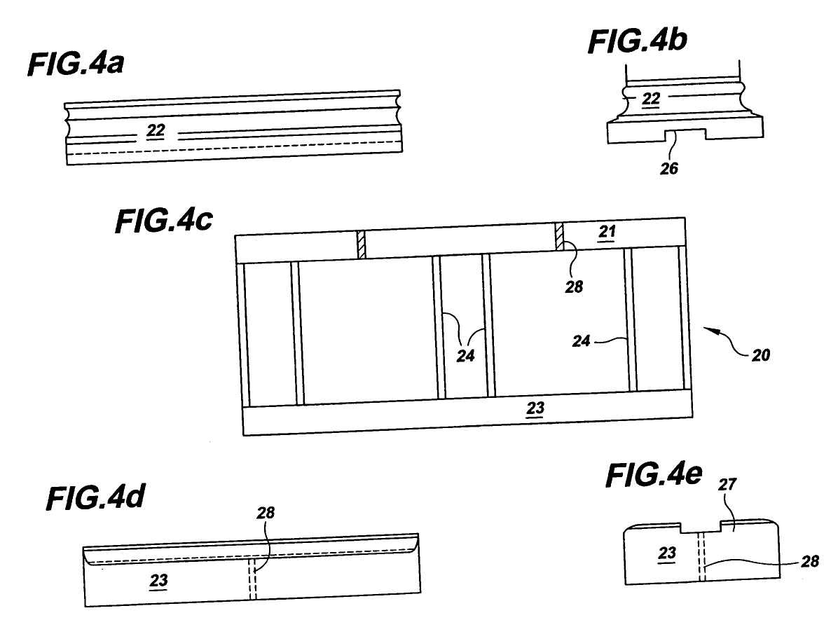

After formation, the composite laminate may then be employed as workable components in a wide range of assemblies. One such assembly, a railing system, is now described with the assistance of FIGS. 4-9.

FIG. 4 illustrates a railing assembly 20 and several views of components thereof, including a handrail 22, a baluster rail 21, a plurality of balusters 24, and a bottom rail 23. All components are preferably manufactured from a composite laminate material, and dimensioned to be assembled together tightly. Handrail 22 is beveled to create an ornamental design that also allows a person to comfortably grip the handrail. The handrail is also mitered to form a notch 26 on the underside into which baluster rail 21 will be glued and/or fastened via screws or nails through holes 28 from the bottom of baluster rail 21, which is out of the field of view of a person standing or sitting proximate to the railing assembly 20. Bottom rail 23 has a corresponding notch 27 on its top surface into which one end of each of the plurality of balusters 24 is inserted, thereby receiving alignment and vertical support from the bottom rail 23. The respective other ends of each of the plurality of balusters are secured to the baluster rail 21, preferably by gluing.

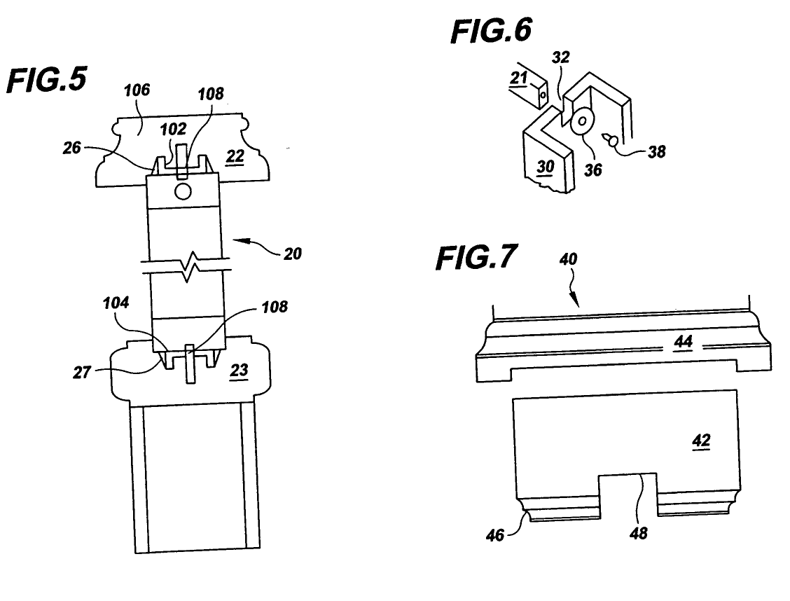

FIG. 5 illustrates an end view of railing assembly 20 wherein the handrail 22 and bottom rail 23 have been optionally reinforced by channels 102 and 104. Channels 102 and 104 are comprised of a rigid, durable material such as, for example, aluminum, that increases the horizontal stability of the handrail and bottom rail. Channels 102 and 104 may comprise a single section or multiple sections of material that run the entire length of the rail or shorter portions thereof where horizontal forces (such as persons leaning against the rail) are of particular concern. The channels 102 and 104 are mateably received by the corresponding notches 26 and 27, respectively. Each contacting flange end point 106 may be timed to assure a tighter mechanical grip, but the primary mechanism for adhering the channels will be fasteners 108 extending through holes (not shown) in the channels into the corresponding rail. The fasteners may be the same fasteners (e.g., screws or bolts) that adhere the railings to the railing posts.

FIG. 6 presents a view of support column 30, which provides support for baluster rail 21. Depending upon the assembly requirements, support column 30 may be solid or have a wholly or partially hollow core. The support column also has a notch 32, for receiving an end of baluster rail 21. The baluster rail may simply be glued into the notch 32, or additionally (or alternatively) a washer 36 and screw 38 may fasten the baluster rail 21 to the support column 30. The handrail 22 and a top cap 40 would be connected on top of the baluster rail 21 and support column 30.

FIG. 7 illustrates one embodiment of a top cap 40, comprised of top assembly 44 that is secured (preferably by gluing) to a bottom assembly 42, which in turn is fastened (also by gluing) to the top of support column 30. Several features of the top cap 40 are worth noting. First, bottom assembly 42 is optionally beveled along edge 46 in such a manner as to allow mating to the beveled surface 28 of top rail 22. This provides a seamless fit and additional interface surface area over which an adhesive may be applied to secure the bottom assembly 42 to handrail 22. Second, bottom assembly 42 includes a notch 48 for integral connection with baluster rail 21. Third, bottom assembly 42 may be hollow to allow access during installation to other components to which the bottom assembly is to be secured.

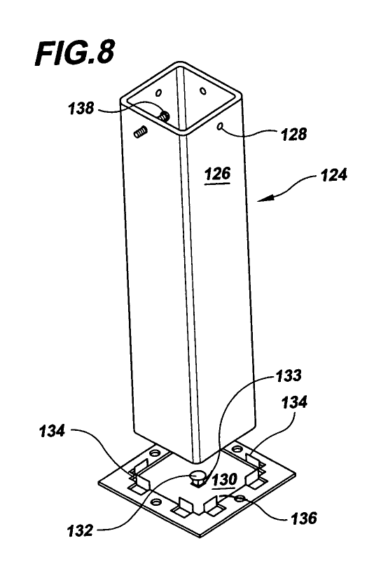

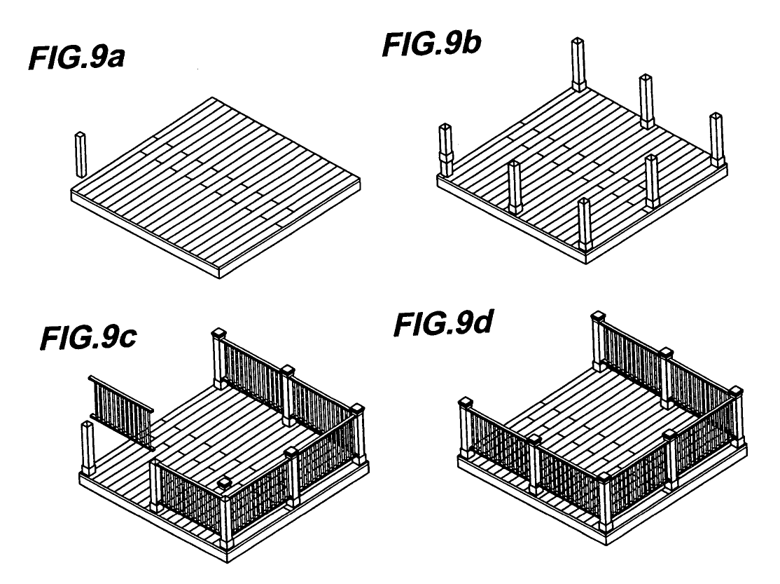

With reference to FIG. 8, the present invention also provides a reinforcement mechanism 124 that is especially suited, though not limited, to providing reinforcement for support columns having a hollow core (such as column 30) that have been formed of the laminate described above. The reinforcement mechanism comprises a core column 126 of a sturdy material such as, for example, aluminum that has dimensions such that it will fit within the hollow column in close proximity, but not contacting the inner the walls of the hollow column being reinforced. The core column 126 is mated to bracket or plate 130 through features such as flanges 134 and grooves 136. The plate 130 is fastened by a carriage bolt 132 through a hole 133 to whatever surface the column and reinforcement mechanism 124 are to be supported by (e.g., a deck, concrete slab, etc.) Once the core column 126 is positioned within the column to be reinforced, a plurality of threaded leveling screws 138 are inserted through threaded holes 128 positioned symmetrically about the sides of the core column 126. The leveling screws 138 are then turned until they contact the inner surface of the hollow column (not shown), and adjusted until the proper orientation of the column has been achieved. Although a square column and one set of four leveling screws near the top of the core column 126 are illustrated, other shapes and leveling screw configurations are possible. If the folded laminate described above is employed as the column material, the result is a sturdy post with no nails or screws externally visible. FIGS. 9a-d illustrate the assembly steps for installing a railing assembly 20 of the present invention.

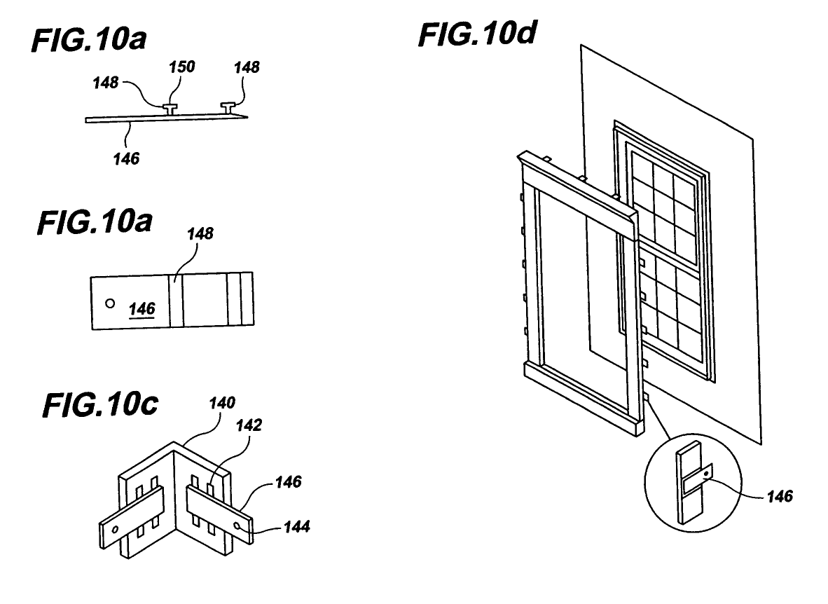

With reference to FIGS. 10-12, the present invention also provides a means for mounting trimboard such as the laminate described above to structures, such as houses, in such a manner that no nails or screws are externally visible.

FIG. 10a provides a side view of a bracket or clip 146 having a plurality of flanges 148 that are dimensioned to snap-fit snugly into a corresponding plurality of mitered kerfs 142 in the back side of a section 140 of trimboard. The flanges 148 may have tined ends 150 to further secure the flange within the kerfs 142. The clip 146 is formed of a rigid, durable material such as, for example, aluminum, and has one or more holes 144. FIG. 10b shows a front view of clip 146. Clip 146 is illustrated with two orthogonally-projecting sections extending from a base section, but could alternatively be configured with one such extending section, or three or more. The lengths and dimensions for the clips are determined by the specific application, but preferably the thickness of the base section is typically in the range of ⅛″ to ½″.

FIG. 10c illustrates a corner trim application of the clips, wherein the assembly of trimboard 140 and two clips 146 is positioned at the desired corner of a house with the clip 146 flush with the exterior wall surface and fasteners (e.g. nails, not shown) are inserted through the hole 144, securing the assembly to the house. As shown in FIG. 10c, the kerfs 142 may extend along a portion of the back of the trimboard 140 that is longer than the width of the clip 146, so that the trim may be slightly adjusted to the desired position before fastening. The flanges (i.e., the sections projecting orthogonally from the base section) 148 are dimensioned to fit snugly within the kerfs or grooves formed in the surface of the trimboard that is to oppose the mounting surface. All surfaces shown are planar to conform to the respective surfaces of the mounting board and trimboard. It is conceivable that one or both of the opposing mounting surface and trimboard are non-flat, in which case the surfaces of the appropriate sections of the clip would be tailored to accommodate such shapes. After fastening, the end of the clip 146 having the hole 144 is covered by whatever shingling is being applied to the house, thereby completely hiding all trim attachment means. As shown in FIG. 10d, the clip 146 is not limited to corner trim, and may be extended to window, fascia or bead board mounting.

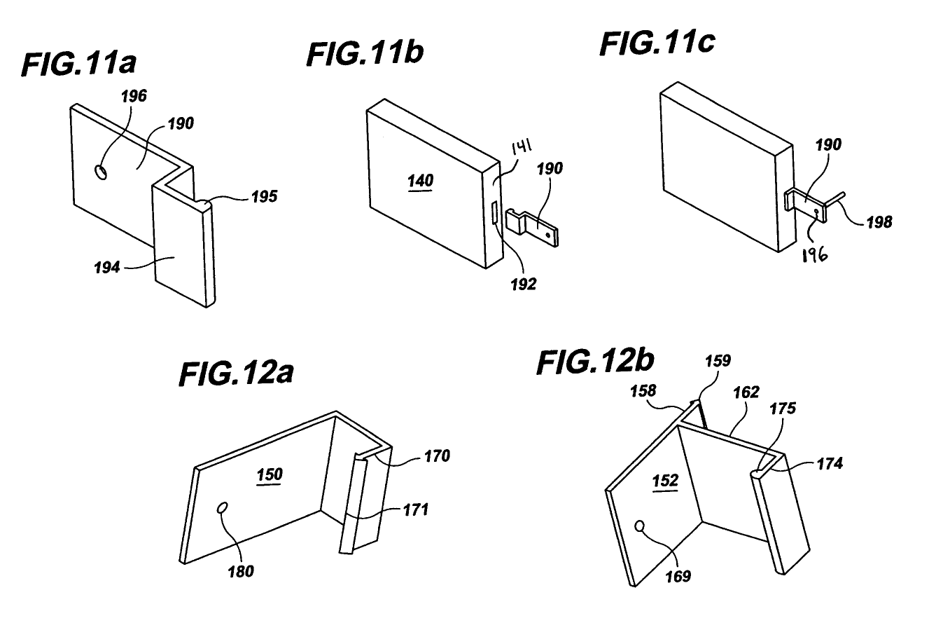

FIGS. 11a-c show an alternative embodiment of a clip 190 for mounting the trimboard 140. Before installation, a groove 192 can be cut in the side surface 141 of trimboard 140 using a standard #20 biscuit saw blade. In most applications, side surface 141 is generally orthogonal to the mounting surface (not shown) to which the trimboard is to be secured. Clip 190 has an L-shaped flange 194 comprised of two sections, one of which is intended to be fully received tightly within a groove 192, the other has a surface substantially conforming to the trim board side surface 141. The distal end of the section received by the groove 192 may terminated in a feature such as, for example, a semicircular shaped protrusion 195 on the designed to further provide a tight fit of the section into groove 192. The other end of the clip has a hole 196 for receiving fasteners 198 to secure the trim 140 to the exterior of the house.

The present invention also provides a means for installing new or retrofitting any type of trim around windows in a more secure manner, and in a manner that overcomes limitations of conventional window trim. Conventional window trim is limited to configurations that abut the window. If an installer wishes to more tightly secure the trim to a window, the installer of conventional trim will most likely have to drill into the window, having the undesirable economic consequence of voiding the window manufacturer's warranty. Additionally, installers are currently limited to installing only the trim provided by the window manufacturer. The present invention allows installation of any style and/or quality of trim to any window.

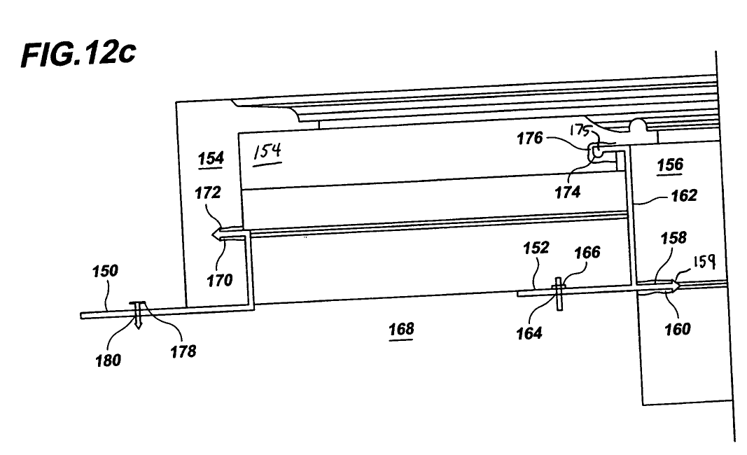

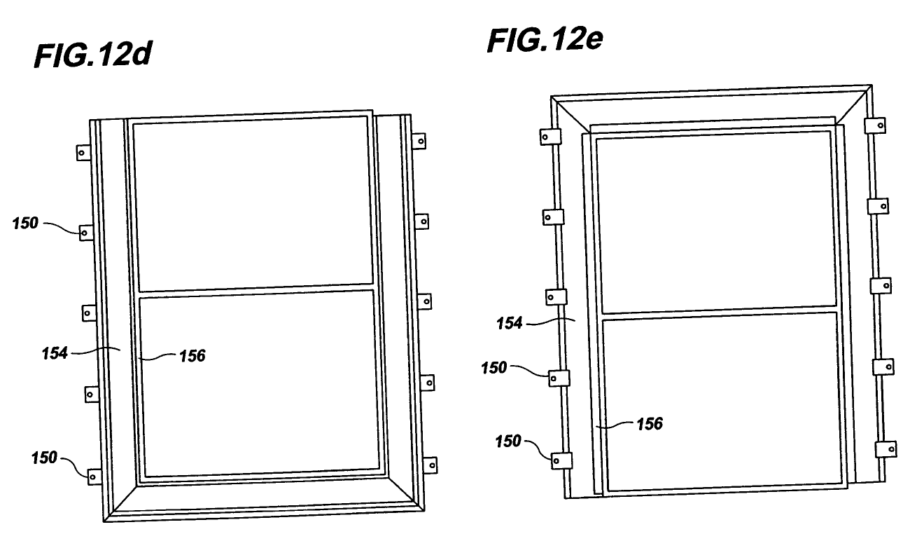

With reference to FIGS. 12a-e, a window trim mounting assembly is comprised of one or more pairs of multi-sectional clips 150, 152 for securely mounting a window trimboard 154 to a window 156. Some windows, notably ANDERSON WINDOWS™, are assembled with a groove 160 that extends along the perimeter or frame of the window 156. First clip 152 has an optional flange 158, with an arrow shaped protrusion 159 on the distal end, for insertion into the window groove 160. The groove 160 and flange 158 serve as a natural alignment means. If the window being trimmed has no such groove, then an embodiment of first clip 152 without flange 158 can be employed. A side surface 162 of the first clip 152 is positioned flush against the side surface of window 156 while the first clip 152 is fastened to the wall 168 by one or more fasteners 166 (e.g., nail or screw) through hole(s) 164. This provides reinforcement for the positioning of the window 156 in the wall 168. The second clip 150 is then connected to trimboard 154 through a flange 170, with an arrow-shaped protrusion 171 on the distal end, which is received by a corresponding first groove 172 in the trimboard 154. This sub-assembly is then slid along the surface of the wall 168 until a second flange 174 of first clip 152 is received by a second groove 176 in the trimboard 154. Second flange 174 has a semicircular-shaped protrusion 175 on the inner surface of the distal end for engagement with groove 176. Once the trimboard has been properly positioned with respect to the first clip 152 and window 156, the second clip 150 is secured to the wall 168 by one or more fasteners 178 through hole(s) 180. Other means could be employed to secure clip 150 and/or clip 152 (and any other clip described herein) to the wall 168, such as adhering the clips with bonding adhesives or cements.

Once the window trim mounting assembly has been secured, with perhaps multiple pairs or clips judiciously disposed about the perimeter of the window (FIGS. 12d-e show front and back view of such placements, respectively), the exposed portion of the second clip 150 can then be covered with whatever shingling is being used on the house exterior, thereby hiding all indication of nails or screws. The foregoing describes a mounting assembly in accordance with the present invention that provides additional structural support for a window and the ability to apply any type of trim to the window in a new installation or a retrofit environment.

Although the invention has been described with respect to certain specific embodiments, it should be realized this invention is also capable of a wide variety of further and other embodiments within the spirit and scope of this invention.

1. A multi-layer composite structure comprising:
a first planar layer of a cellular PVC-based trimboard;
a second planar layer of the cellular PVC-based trimboard; and
said first planar layer and said second planar layer being fastened together by a connecting means at a planar interface;
wherein said multi-layer composite structure exhibits increased stiffness and strength in a direction normal to the planar interface, increased longitudinal shear strength, and increased axial load strength.

2. The structure of claim 1, wherein said connecting means comprises one of the following: nailing, screwing, or bonding with construction adhesive or PVC cement.

3. The structure of claim 2, further comprising:
a plurality of shaped grooves spaced along a top planar surface, said grooves allowing the multi-layer composite structure to be folded into a variety of forms.

4. The structure of claim 3, wherein said variety of forms comprises a hollow column or a solid column, said hollow column or solid column having only one visible seam.

5. A railing assembly comprising:
a hollow support column formed of the multi-layer composite of claim 1 adapted to be mounted perpendicular to a supporting surface, said hollow column including a plurality of side surfaces, wherein at least one of a plurality of side surfaces includes a notch extending from a top of the hollow support column; and
a railing formed at least in part of the multi-layer composite of claim 1, said railing comprising:
a handrail adapted to be mounted parallel to said supporting surface, said handrail including a notch extending along a length of a lower surface,
an upper baluster rail adapted to fit within said notch of said handrail and adapted to fit into said notch of said support column,
a lower baluster rail including a notch extending along a length of an upper surface,
a plurality of balusters extending from said upper baluster rail to said lower baluster rail, said plurality of balusters being received within said notch of said lower baluster rail,
said railing assembly being free from visible mechanical fasteners.

6. The railing assembly of claim 5, wherein said handrail is mounted to said upper baluster rail by a first connecting means and said upper baluster rail is mounted to said support column by a second connecting means, and said plurality of balusters are mounted to said lower baluster rail by a third connecting means.

7. The railing assembly of claim 6, wherein any of said first, second and/or third connecting means are chosen from one of the following: gluing, nailing or screwing.

8. The railing assembly of claim 5, wherein said handrail and/or said lower baluster rail include a reinforcement channel, said channel being composed of a durable rigid material for increasing horizontal stability of the railing assembly.

9. The railing assembly of claim 5, further comprising:
a hollow reinforcing post mountable to a deck or said supporting surface, said post including a plurality of side surfaces, wherein at least one of the plurality of side surfaces includes a hole for a second connecting means, wherein said hollow column surrounds said reinforcing post and is fixed to said reinforcing post by said second connecting means.

10. The railing assembly of claim 5, wherein said reinforcing post is composed of a rigid metal material.

11. A trimboard mounting assembly, comprising:
a first window trim clip including
a first planar section having a proximal and distal end and a surface substantially conforming to a wall surface,
a second planar section having a proximal and a distal end, said second planar section extending at the proximal end orthogonally from said first planar section, said second planar section having a surface substantially conforming to the window frame, and
a third planar section having a proximal and a distal end, said third planar section extending at the proximal end orthogonally from said distal end of second planar surface and substantially parallel to and spaced apart from said first planar surface, said distal end of said third planar section shaped to be securely received within a first groove of a window trimboard; and
means for securing the first window trim clip to the wall.

12. The assembly of claim 11, wherein:
the distal end of said first planar section is shaped to be received within a groove of a window frame; and
the second planar section extends from the first planar section from a position spaced between the proximal end and distal end of the first planar section.

13. The assembly of claim 11, wherein said securing means comprises:
at least one fastener; and
a corresponding number of holes in said first planar section adapted to receive the at least one fastener.

14. The trimboard mounting assembly of claim 11, further comprising:
a second window trim clip, said second window trim clip comprising:
a first planar section having a proximal and a distal end and a surface substantially conforming to the wall surface,
a second planar section having a proximal and a distal end, said second planar section extending orthogonally from said distal end of said first planar section, and
a third planar section having a proximal and a distal end, said third planar section extending orthogonally from said second planar surface and parallel to and spaced apart from said first planar section, said proximal end of said third planar surface being connected to said distal end of said second planar surface, and said distal end of said third planar section shaped to be securely received within a second groove of the window trimboard; and
means for securing the second window trim clip to the wall.

15. The assembly of claim 14, wherein said securing means comprises:
at least one fastener; and
a corresponding number of holes in said first planar section adapted to receive the at least one fastener.

16. A trim clip assembly for mounting a trimboard to a mounting surface, the trimboard having at least one groove in a surface to oppose the mounting surface, the trim clip comprising:
a member having a first surface and a second surface, said first surface substantially conforming to the mounting surface and said second surface substantially conforming to the surface of the trimboard opposing the mounting surface;
at least one protrusion extending from said second surface, wherein said at least one protrusion is adapted to fit within a corresponding one of said at least one groove of said trimboard; and
means for securing said member to said mounting surface.

17. The trim clip assembly of claim 16, wherein said at least one protrusion has an arrow-shaped distal end.

18. The trim clip assembly of claim 16, wherein said attachment means includes a hole in said member for receiving a fastener.

19. A trim clip assembly for mounting a trimboard to a mounting surface, the trimboard having a groove in a surface orthogonal to the mounting surface, comprising:
a trim clip having
a first planar section having a proximal end and a distal end and a surface substantially conforming to the mounting surface,
a second planar section having a proximal end and distal end, said second planar sectionextending orthogonally from said distal end of said first planar surface, said second planar section further including a surface between said proximal and distal ends substantially conforming to trimboard surface having said groove, and
a third planar section extending orthogonally from the distal end of the second planar section, said third planar section shaped to be securely received within the groove of the mounting surface; and
means for securing the trim clip to the mounting surface.

20. The trim clip assembly of claim 19, further comprising:
a trimboard with a side surface, said side surface including at least one groove parallel to said mounting surface for mateably receiving said trim clip.
